(19) United States
(12) Patent Application Publication
(10) Pub. No.: US 2007/0257772 A1
(43) Pub. Date: Nov. 8, 2007

(54) Electronic proximity security system

(76) Inventors: Jesse Marcelle, Muskego, WI (US); Glenn Meekma, Menomonee Falls, WI (US); Vince Leslie, Greendale, WI (US); Tim Ebner, Menomonee Falls, WI (US)

Correspondence Address: CALFEE, HALTER & GRISWOLD LLP, 1400 KEYBANK CENTER, 800 SUPERIOR AVENUE, CLEVELAND, OH, 44114, US

(21) Appl. No.: 11/377,448

(22) Filed: Mar. 16, 2006

Related U.S. Application Data
(60) Provisional application No. 60/594,186, filed on Mar. 17, 2005.

(51) Int. Cl. G05B 19/00

(52) U.S. Cl. 340/5.64; 340/569; 340/5.7

(57) ABSTRACT

A system for controlling access to a securable area. The system includes a transmitter, a receiver, a logic circuit, an energy storing device, and a locking mechanism. The transmitter remotely transmits a signal that is selectively received by the receiver. The receiver includes an active and an inactive state. The logic circuit is in communication with the receiver and includes an active and an inactive state. The logic circuit is in communication with the energy storing device, which is in communication with the locking mechanism. When the receiver receives the signal from the transmitter, the locking mechanism selectively allows access to the securable area.

### CROSS-REFERENCE TO RELATED APPLICATIONS

This non-provisional application claims the benefit of U.S. Provisional Patent Application No. 60/594,186, entitled “Batteryless Electronic Proximity Security Device,” filed Mar. 17, 2005.

### FIELD OF THE INVENTION

This invention relates generally to remotely locking and unlocking a securable area. The invention specifically relates to evaluating security codes in determining whether to secure or unsecure a securable area.

### BACKGROUND OF THE INVENTION

Securable areas, such as containers, rooms, yards, and the like, are often secured by a locking device. Locking devices normally include apparatus and methods of locking and unlocking the device. Typical methods require that a person seeking to lock or unlock a lock be positioned very close to the device. For example, a key lock or combination lock require that a person be close enough to the lock to physically manipulate the lock with a proper key or a combination dial to lock or unlock the locking device. It is desirable to develop apparatus and methods of remotely securing and unsecuring a securable area.

Apparatus and methods that have been designed and developed for remotely securing and unsecuring a securable area commonly require a power source, typically electrical power stored in a battery, to lock and unlock a locking device. Such systems can require frequent maintenance and service time often is limited by the useful life of the battery. It is desirable to develop apparatus and methods for remotely securing or unsecuring a securable area that limit the amount of maintenance needed and limit the energy needed to power such apparatus and methods.

### SUMMARY OF THE INVENTION

This invention is directed to apparatus and methods for securing and unsecuring a securable area or space. The apparatus and methods are designed to control the access to the securable area remotely from a location generally proximate to the securable area. Optionally, energy or power conserving apparatus and methods are included in the apparatus and methods described herein.

An embodiment of the invention provides for an energy conserving system for controlling access to a securable area. The system includes a transmitter, a receiver, a logic circuit, an energy storing device, and a locking mechanism. The transmitter remotely transmits a signal that is selectively received by the receiver. The receiver includes an active and an inactive state. The logic circuit is in communication with the receiver and includes an active and an inactive state. The logic circuit is in communication with the energy storing device, which is in communication with the locking mechanism. When the receiver receives the signal from the transmitter, the locking mechanism selectively allows access to the securable area.

### DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention. The drawings and detailed description are not intended to and do not limit the scope of the invention or the claims in any way. Instead, the drawings and detailed description only describe embodiments of the invention and other embodiments of the invention not described are encompassed by the claims.

FIG. 1 is a schematic representation of an exemplary embodiment of an electronic proximity security system in accordance with the present invention;

FIG. 2 is a schematic representation of a signal used in the system of FIG. 1;

FIG. 3A is a schematic representation of an exemplary embodiment of a latching mechanism of FIG. 1 in the locked position;

FIG. 3B is a schematic representation of an exemplary embodiment of a latching mechanism of FIG. 1 in the unlocked position;

FIGS. 4A and 4B are a flow chart showing an exemplary method of using the system of FIG. 1;

FIG. 5 is a perspective view of the system of FIG. 1 applied to a mailbox;

FIG. 6 is an exploded view of the mailbox of FIG. 5;

FIG. 7 is a cross-sectional view of the mail-box of FIG. 5, with the door locked; and

FIG. 8 is a cross-sectional view of the mail-box of FIG. 5, with the door unlocked.

### DETAILED DESCRIPTION

The Detailed Description of the Invention merely describes preferred embodiments of the invention and is not intended to limit the scope of the claims in any way. Indeed, the invention as described by the claims is broader than and unlimited by the preferred embodiments, and the terms in the claims have their full ordinary meaning.

As described herein, apparatus and methods can be designed for remotely locking and unlocking a securable area or space, such as for example, rooms, fenced in yards, storage bins, containers, and the like. Such securable areas are typically secured by locking an access device, such as for example, a door, hatch, and the like. Apparatus and methods for remotely locking and unlocking can be arranged such that only authorized persons are able to lock or unlock the securable area. When an attempt is made to unlock the securable area, the apparatus and methods used are subject to an authentication process to determine whether the securable area should be unlocked.

Such apparatus and methods typically rely on energy, such as electrical energy, to power the authentication process and the locking and unlocking of the securable area. Conserving energy, by limiting the amount of energy or power needed to authenticate a user or lock and unlock the securable area, can extend the service life of such apparatus and decrease the occurrences of downtime due to the exhaustion of the energy supply. In addition, conserving energy can reduce the amount of maintenance by limiting the frequency at which an energy supply, such as an electric battery, needs to be exchanged.

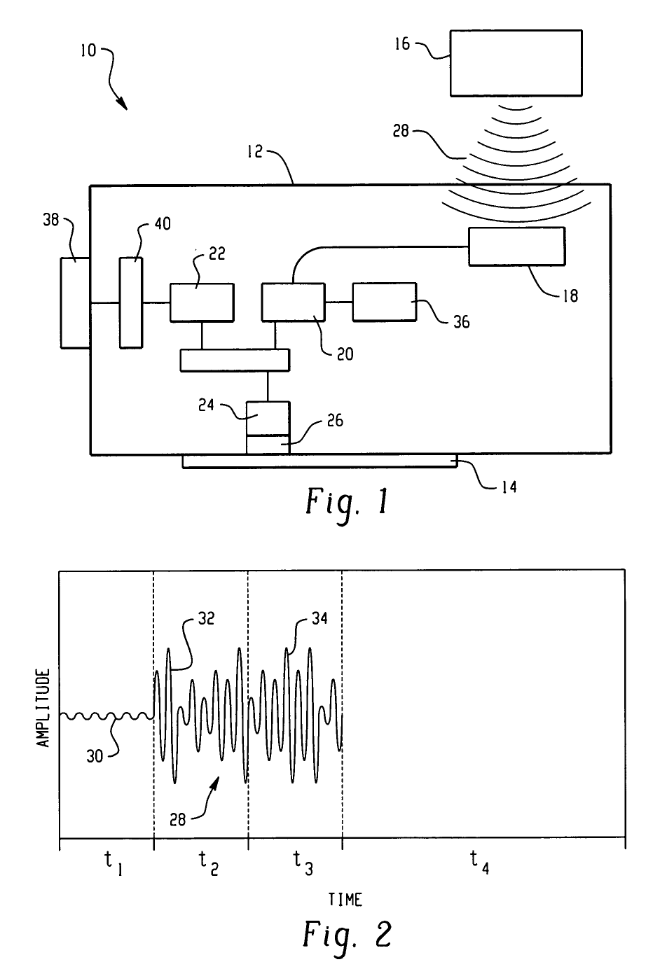

FIG. 1 illustrates a schematic representation of an exemplary embodiment of an electronic proximity security assembly or system 10. The security system 10 includes a securable area or space 12 and an access device 14 by which the securable area 12 can be accessed. The terms securable area 12 and access device 14 represent a broad variety of components. For purposes of the description of FIG. 1, the securable area 12 will be referred to as a container and the access device 12 will be referred to as a door.

The security system 10 is remote in the sense that an authorized user can lock or unlock the door 14 of the container 12 without having physical contact with the door 14 or container 12. Preferably a user can lock or unlock the door 14 only when the user is proximate to the container 12. For example, the system 10 can be arranged to allow a user to unlock the door 14 only when the user is within three meters of the container 12. To accomplish remote locking and unlocking of the door 14, the system 10 includes a transmitter 16, a receiver 18, a logic circuit 20, an energy storing device 22, an actuator 24, and a latching mechanism 26.

The process of unlocking the door 14 begins with the transmitter 16 generating a signal 28 that can be received by the receiver 18. The receiver 18 receives the signal 28 when the receiver 18 is within range of the transmitter 16. As will be described in detail, the signal 28 contains information for use by the receiver 18 and other elements of the system 10 to authenticate a user and determine whether the door 14 should be unlocked. The receiver 18 is in electrical communication with the logic circuit 20. Once the receiver 18 receives the information carried by the signal 28, the receiver 18 and, optionally, the logic circuit 20 can interpret the information to authenticate the signal 28 as originating from an authorized transmitter 16 or authorized user. The logic circuit 20 is in electrical communication with the energy storing device 22, which is in electrical communication with the actuator 24. The actuator 24 is coupled to the latching mechanism 26, which physically locks and unlocks the door 14. The actuator 24 controls the position of the latching mechanism 26, which determines whether the door 14 is locked or unlocked.

If the signal 28 is authenticated, the logic circuit 20 instructs the energy storing device 22 to deliver energy to the actuator 24. This energy powers the actuator 24 to position the latching mechanism 26 such that the door 14 is unlocked. In alternative arrangements, the energy storing device 22 may stop delivering power to the actuator 24 or alter the power delivered to the actuator 24 to cause the door 14 to unlock. If the signal 28 cannot be authenticated by the receiver 18 and/or the logic circuit 20, the logic circuit 20 takes no actions to unlock the door 14.

The processes of receiving the signal 28, evaluating the information, and unlocking the door 14 all consume energy and power. The components of the security system 10 can be configured to minimize the use of energy and power. Some securable areas 10 may seldom require unlocking. For example, a secured mailbox may only be unlocked twice a day, once when a postal carrier delivers mail and once when the recipient picks-up mail. For the vast majority of the day, such containers may remain locked. If the receiver 18 and the logic circuit 20 remained active at all times, the energy used to maintain this active status would be wasted, with the exception of the two instances a day that the container 12 is unlocked. To minimize the energy used by the receiver 18 and the logic circuit 20, each is configured to have an active state and an inactive or dormant state. When the receiver 18 and logic circuit 20 are in the active state, information from the signal 28 can be interpreted and used to make decisions. When the receiver 18 and logic circuit 20 are in the inactive state, the information cannot be interpreted. In order for this configuration to be useful, the receiver 18 and logic circuit 20 need to be awakened, or moved from the inactive state to an active state, when information requires interpretation. One method of moving the receiver 18 from an inactive state to an active state is to use a portion of the signal 28 transmitted from the transmitter 16 to awaken the receiver 18.

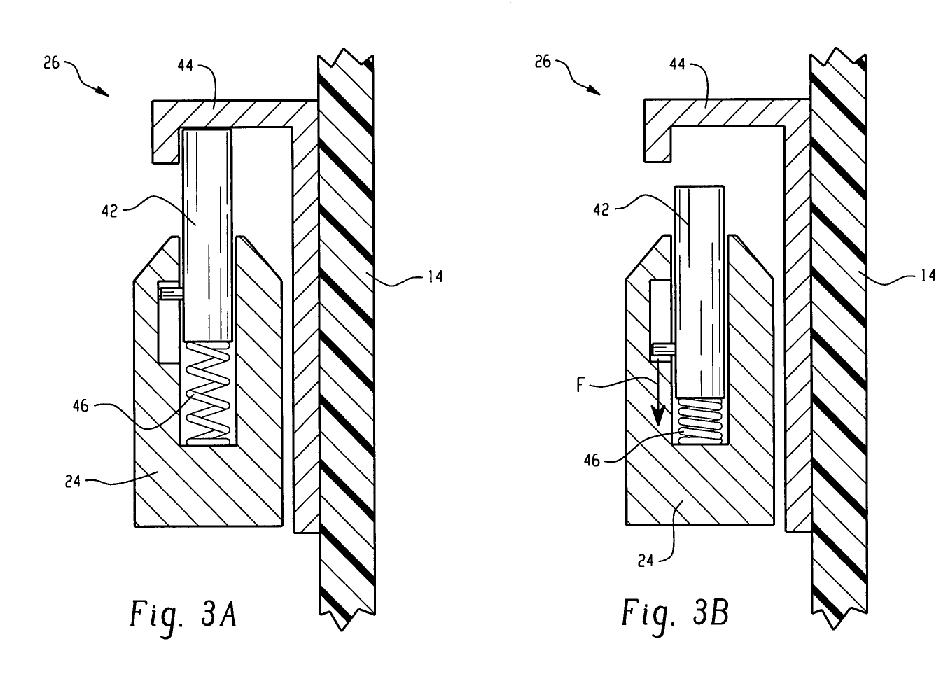

A schematic representation of a signal 28 is illustrated in FIG. 2. A first portion 30 of the signal 28 is an unmodulated sine wave. This unmodulated portion 30 does not carry any information. This first portion 30 is designed to provide energy to the receiver 18 to awaken the receiver 18 and moves it from an inactive state to an active state. Once the receiver 18 is in the active state, the receiver 18 receives a second portion 32 of the signal 28. This second portion 32 of the signal 28 is modulated and contains a first security code that is read and interpreted by the receiver 18. The receiver 18 compares the first security code to a first access code stored on the receiver 18. Optionally, the energy required to interpret the first security code and compare it to the first access code can be derived from the signal 28. This minimizes the energy needed from electric storing device 22 to operate the system 10.

If the first security code does not match the first access code, the receiver 18 returns to the inactive state. If the first security code does match the first access code, the user is partially authenticated and the receiver 18 sends a message to the logic circuit 20 to awaken the logic circuit 20 and move it from an inactive state to an active state. In addition, the receiver 18 receives a third portion 34 of the signal 28 and passes that portion 34 on to the logic circuit 20. The third portion 34 of the signal 28 is modulated and contains a second security code. The second security code is interpreted by the logic circuit 20 and compared to a second access code stored on the logic circuit 20. Alternatively, the second access code can be stored on a nonvolatile memory circuit 36 that is in communication with the logic circuit 20. If the second security code does not match the second access code, the logic circuit 20 takes no action and returns to an inactive state. If the second security code matches the second access code, the user is fully authenticated and the logic circuit 20 sends a message to the energy storing device 22 to energize the actuator 24, which positions the latching mechanism 26 to unlock the door 14.

Although the embodiment illustrated by FIGS. 1 and 2 disclose a first and second security code, it should be understood that any number of security codes can be incorporated on a signal. In addition, the complexity of each security code can be varied to offer the appropriate amount of security. For example, one eight bit code offers 256 unique codes, while one twenty-four bit code offers nearly 17 million unique codes.

Optionally, the signal 28 may include information other than security codes. For example, in a circumstance where there are multiple authorized users, the signal 28 can include information on the identity of the current user. This information can be stored on the nonvolatile memory circuit 36 to form an audit trail of access to the container 12. This audit trail can include time and date of each access, the duration of access, and other such information. This audit trail can be retrieved from the memory circuit 36 as needed. The information in the audit trail can be presented through a display screen, a printed report, or other such methods to those security persons authorized to view such information.

The actuator 24 and latching mechanism 26 can be arranged to minimize the energy needed to maintain the door 14 in an unlocked or locked position. If the electronic proximity security system 10 is a mailbox as previously described, the door 14 will remain locked for a large majority of the time and be unlocked for a small minority of the time. Under this circumstance, energy usage can be minimized if the latching mechanism 26 is positioned to lock the door 14 when the energy storing device 22 is not energizing or powering the actuator 24. Energy usage by the actuator 24 can be limited to holding the latching mechanism 26 in a position that unlocks the door 14. One example of such an arrangement is to use a mechanical spring to position the latching mechanism 26 such that the door 14 is locked. When an authorized user requests the door 14 be unlocked, energy from the energy storing device 22 can power the actuator 24 to over come the force of the mechanical spring and position the latching mechanism 26 to unlock the door 14.

Alternatively, the security system 10 may be used such that the door 14 is unlocked a majority of the time. A mechanical spring can be positioned to hold the latching mechanism 26 into a position where the door 14 is unlocked. Energizing the actuator 24 would move the latching mechanism 26 to a position where the door 14 is locked.

The energy storing device 22 can be any device that is capable of storing energy. For example, a single use battery or a rechargeable battery can be used. A single use battery would power the system 10 until its useful life is exhausted, at which time the exhausted single use battery could be exchanged for new single use battery. The rechargeable battery could be connected to a source of power that recharges the battery. FIG. 1 illustrates a solar panel 38 attached to the energy storing device 22. The solar panel 38 transforms natural light into electricity and the electricity generated can be stored in a rechargeable battery 22. The electricity generated by the solar panel 38 passes through a power conditioner 40 to make the electricity suitable for storage. The solar panel 38 is an exemplary device for providing energy to a rechargeable energy storage device 22. Other such devices that can keep a rechargeable energy storage device 22 charged include a windmill and a power cord connected to an outlet. Optionally, the energy storing device 22 can be one or more super capacitors. Super capacitors can have a service life of approximately twelve years. This exceeds the service life of a typical single use or rechargeable battery.

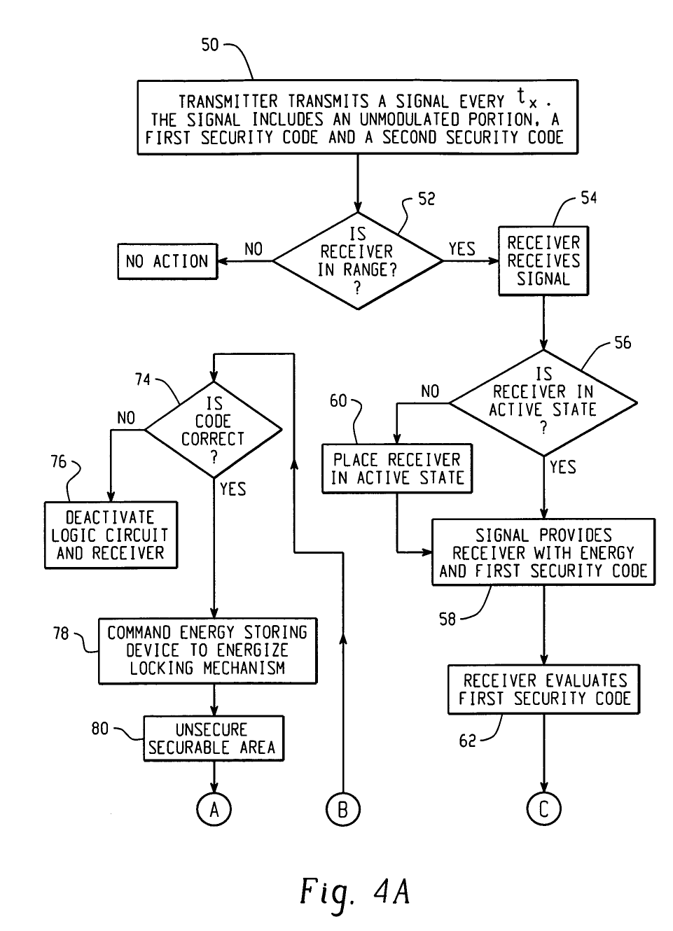

The latching mechanism 26 can be comprised of standard mechanical components. Referring to FIGS. 3A and 3B, the latching mechanism 26 can include a plunger 42, located at least partially in the actuator 24, and an L-shaped latch 44 coupled to the door 14. As seen in FIG. 3A, when the actuator 24 is not energized, a spring 46 positions the plunger 42 such that it secures the latch 44. As seen in FIG. 3B, when the actuator 24 is energized a force F moves the plunger 42 downward, with respect to FIG. 3B. This positions the plunger 42 such that the latch 44 is unsecured and the door 14 is free to open by a user. This description is exemplary only and the latching mechanism can include any arrangement of components that can secure and unsecure the access device 14 of a securable area 12.

Optionally, the electronic proximity securing system 10 can include a power regulator 48 in communication with the energy storage device 22, the actuator 24, and logic circuit 20. The power regulator 48 regulates the energy flowing from the energy storing device 22 to other components in the system 10 powered by the energy storage device 22.

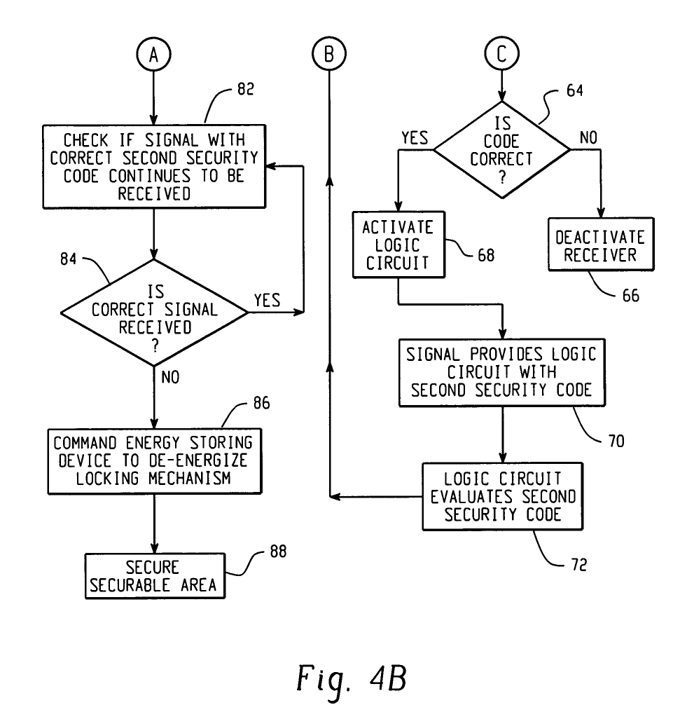

Referring to FIGS. 4A and 4B, a flow chart is shown representing an exemplary method utilizing the embodiment illustrated in FIG. 1 and FIG. 2. The transmitter 16 transmits the signal 28 at regular intervals at step 50. As seen in FIG. 2, the signal 28 is sent over time periods t₁, t₂, and t₃. Over the time period t₄, no signal is sent. At the conclusion of time period t₄, the cycle is repeated by the transmitter 16. The duration of time periods t₁, t₂, t₃, and t₄ can be any durations. In one example, the durations of time periods t₁, t₂, and t₃ are approximately 100 to 150 milliseconds each and the duration of time period t₄ is approximately 1.5 seconds. Typically, an authorized person carries a transmitter 16. As an authorized person approaches the container 12, the time periods as described allows the security system 10 adequate time to evaluate the signal 28 and unlock the door 14 before the user arrives at the container 12 and attempts to open the door 14.

When the signal 28 is transmitted by the transmitter 16, a check is performed at step 52 to determine if the receiver 18 is in range of the signal 28. If the receiver 18 is out of range, no action occurs. If the receiver is in range, the receiver 18 receives the signal 28 at step 54. At step 56 a check is performed to determine whether the receiver 18 is in an active state. If the receiver is already in an active state, the receiver 18 receives energy and the first security code in step 58. If the receiver 18 is in a dormant or inactive state, the first portion 30 of the signal 28 places the receiver 18 in the active state at step 60. The receiver 18 then receives energy and the first security code at step 58. The receiver 18 evaluates the first security code at step 62. At step 64, it is determined if the first security code is correct or incorrect. If the first security code is incorrect, the receiver returns to the inactive state at step 66. If the first security code is correct the logic circuit 20 is activated at step 68. The signal 28 provides the logic circuit 20 with the second security code at step 70 and the logic circuit 20 evaluates the second security code at step 72. At step 74, it is determined if the second security code is correct or incorrect. If the second security code is incorrect, the logic circuit 20 and receiver 18 return to the inactive state at step 76. If the second security code is correct, the logic circuit 20 commands the energy storing device 22 to energize the locking mechanism at step 78. This causes the securable area 12 to be unlocked at step 80. The logic circuit 20 continues to periodically sample the receiver 18 at step 82. At step 84 it is determined whether the second security code continues to be received by the receiver 18. If the second security code continues to be received, the logic circuit 20 makes no changes. If the second security code is no longer received, the logic circuit 20 commands the energy storing device 22 to de-energize the locking mechanism at step 86. The de-energizing of the locking mechanism 26 causes the securable area to be secured at step 88.

Once the securable area 12 is unlocked, the user can lock the securable area 12 by moving the transmitter 16 out of range of the receiver 18. This can be accomplished by simply walking away from the securable area 12 with the transmitter 16.

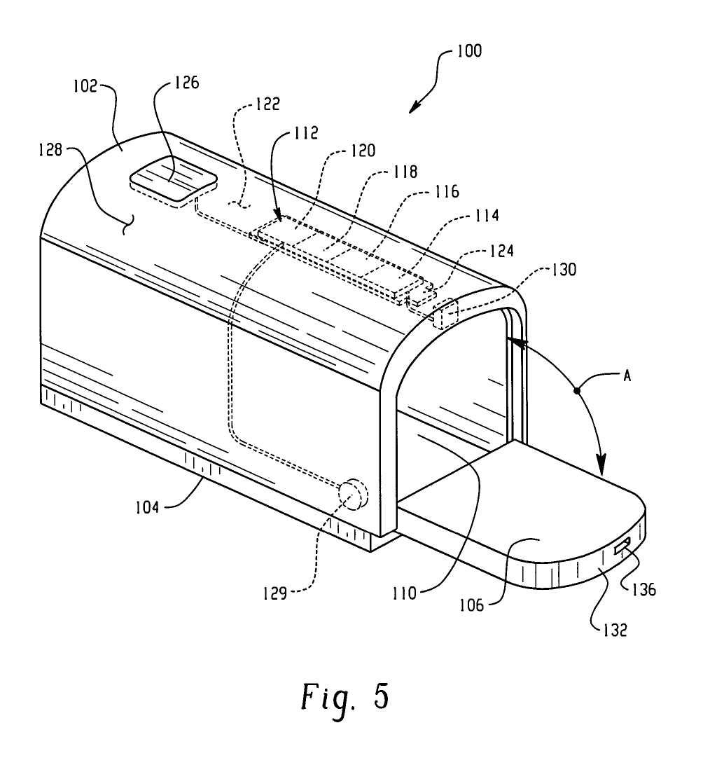

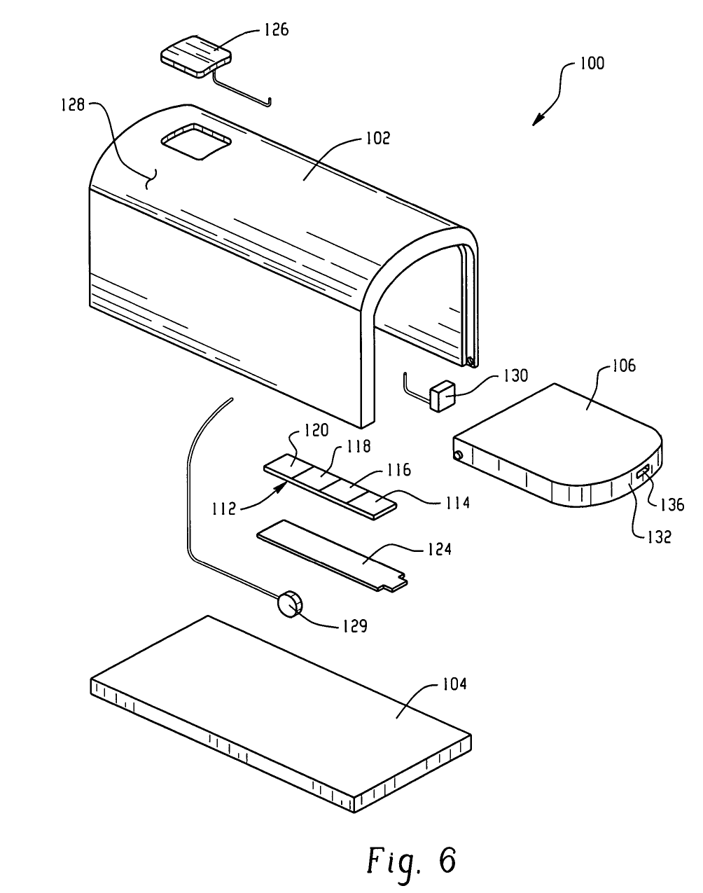

FIGS. 5 through 8 illustrate an exemplary embodiment of a mailbox 100 configured with an electronic proximity security system. As best seen in the perspective view of FIG. 5 and the exploded view of FIG. 6, the mailbox 100 includes a mailbox top 102, a mailbox bottom 104, and a door 106. The mailbox top 102 and bottom 104 are coupled together and the door 106 is hinged to the mailbox top 102. The door 106 can be opened and closed along the arc A, as shown in FIG. 5. When the door 106 is closed a securable area 110 is defined by the mailbox top 102, bottom 104, and door 106.

The mailbox 100 includes a printed circuit board (PCB) 112. The PCB 112 houses a receiver 114, a logic circuit 116, a nonvolatile memory circuit 118, and at least one super capacitor 120. The infrastructure of the PCB 112 places all the components 114, 116, 118, and 120 in communication with each other. As best seen in FIG. 5, the PCB 112 is mounted on an interior surface 122 or the mailbox top 102. A cover plate 124 is mounted over the PCB 112 to protect the PCB 112 from damage and debris.

A solar panel or cell 126 is mounted on an exterior surface 128 of the mailbox top 102 and is in communication with the PCB 112. The solar cell 126 generates energy that is channeled to the super capacitor 120 for storage. Optionally, additional renewable energy sources may be incorporated into the mailbox 100. For example, additional solar cells can be added to generate more electricity or adjust for geographic areas of the country that may experience less sunshine. A piezo device 129 may be added to charge the super capacitor 120. The piezo device 129 can be added to any location where a force may be applied to the device. One such location is near where the door 106 contacts the mailbox top 102 upon closing. A piezo device 129 can be arranged such that when the door 106 is opened or closed, a force is applied to the piezo device 129. This force generates an electric field that can be harnessed, channeled to the super capacitor 120, and stored for future use by the mailbox 100. Alternatively, a rechargeable battery can be used and recharged by the solar cell 126 and/or a piezo device, or other renewable sources of energy.

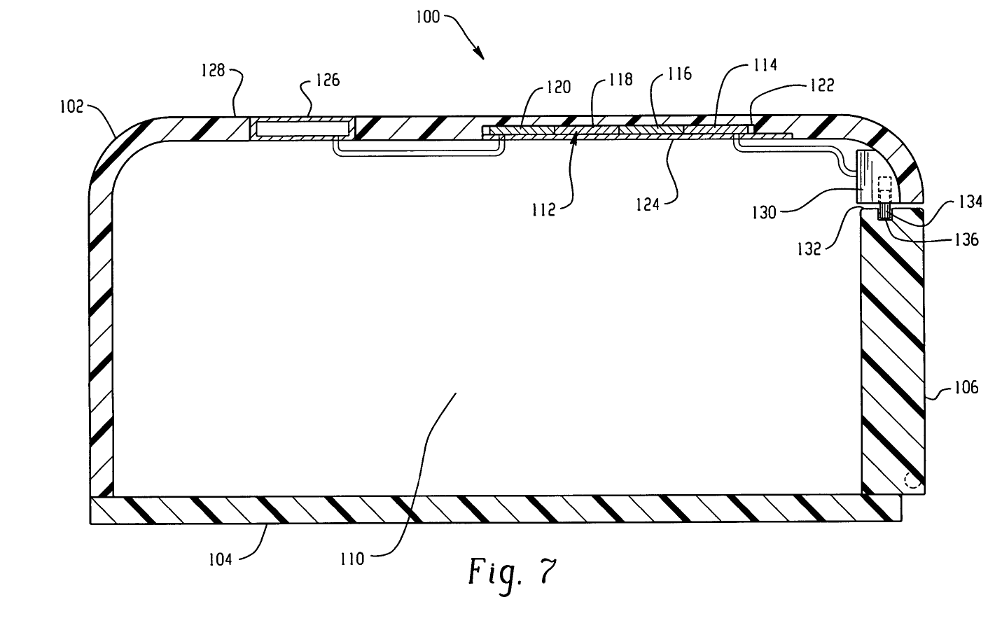

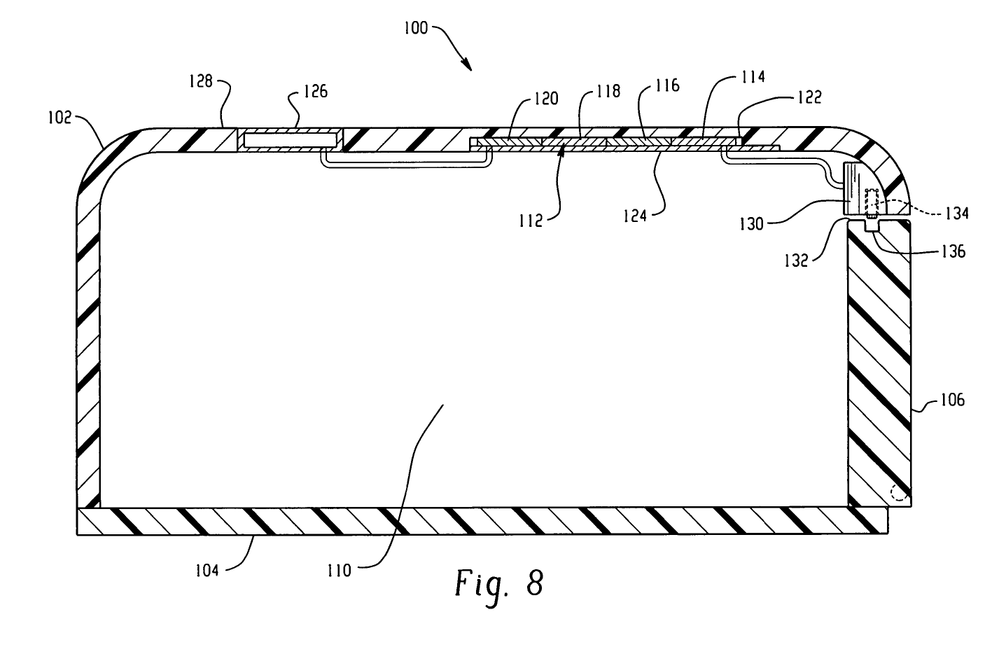

An actuator 130 is mounted on the interior surface 122 of the mailbox top 102 proximate to where the top edge 132 of the door 106 is positioned when the door 106 is closed. The actuator 130 is in communication with the PCB 112. The latching mechanism includes a plunger 134, located at least partially within the actuator 130 (as seen in FIGS. 7 and 8), and a slot or aperture 136 in the top edge 132 of the door 106. The door 106 is locked when the door 106 is closed and the plunger 134 extends from the actuator 130 and locates in the slot 136 of the door 106, as shown in FIG. 7. The door is unlocked when the plunger 134 is retracted into the actuator 130 and free of the slot 136 in the door 106, as shown in FIG. 8.

The transmitter (not shown) of this embodiment is a radio frequency transmitter. Typically, the transmitter is of a design commonly utilized by radio frequency identification (RFID) technology. The receiver 114 is an RFID receiver. The signal transmitted is a radio signal, with three portions, similar to the schematic illustrated in FIG. 2, and includes the unmodulated wake-up portion, along with a first and second security code, as described herein.

A secured mailbox 100 can be highly desirable. Received mail is often confidential or contains personal information, such as social security numbers and bank statement information. Outgoing mail is often left in mailboxes for pickup by a postal carrier. Outgoing mail also contains personal and sensitive information, such as checks and personal correspondence. Preferably, a secured mailbox 100 is able to protect delivered mail as well as outgoing mail. As previously described, a mailbox is accessed as seldom as two times a day by two distinct authorized users, i.e., a postal carrier and the mailbox owner. If the postal carrier had a transmitter that transmitted the proper security codes, the postal carrier could unlock the mailbox 100 to deposit the incoming mail and remove the outgoing mail and then relock the mailbox 100. Likewise, the mailbox owner can unlock the mailbox 100 with a transmitter to deposit outgoing mail and/or retrieve incoming mail and relock the mailbox 100.

A postal carrier needs to service hundreds of mailboxes per day. Having a unique transmitter for each mailbox is impractical. Mailboxes can be arranged to open for a generic code generated by a post office RFID transmitter. This allows the postal carrier to open many mailboxes with the same transmitter. This system offers efficiency for the postal carrier and the same level of security as the current generic key system used by the United States Post Office. In this system, many mailboxes are arranged to be unlocked by a generic key used by postal carriers. The use of RFID transmitters offers efficiencies over generic key systems. Because the transmitter repeatedly sends the signal, the mailboxes 100 will open as the postal carrier approaches the mailbox 100 without any additional affirmative actions, such as using a key to unlock the mailbox. In the embodiment shown, the mailbox 100 is arranged such that the door 106 remains closed even when the postal carrier's transmitter has unlocked the door 106. The postal carrier will need to pull on a handle attached to the door 106 to open the mailbox 106. The door 106 can optionally be spring loaded so that the door 106 closes automatically when the postal carrier is done placing the incoming mail in the mailbox 100 and retrieving the outgoing mail from the mailbox 100. A postal carrier simply continuing on the route and moving the transmitter out of range of the receiver 114 will lock the mailbox 100.

The transmitter used by the mailbox owner would not include the generic post office security code. The owner's transmitter would contain a security code specific to the owner's mailbox 100. Under this arrangement, the receiver 114 and logic circuit 116 recognize at least three codes as correct access codes: a security code evaluated by the receiver 114 to determine if the logic circuit 116 should be activated, a post office security code evaluated by the logic circuit 116 to grant access to the mailbox 100 to a postal carrier, and an owner's security code evaluated by the logic circuit 116 to grant access to the mailbox 100 to the owner.

Optionally, the owner's transmitter may send out a signal only on command, as opposed to a sending out the signal in a repeating cycle. Since the owner will only use the transmitter once or twice a day, the transmitter can be arranged such that a button can be pressed to send the signal. This arrangement minimizes the energy used by the owner's transmitter without inconveniencing the owner.

Although apparatus and methods are discussed in reference to a mailbox 100, a mailbox 100 is used for illustrative purposes only. It should be readily understood that such apparatus and methods can be applied to a large variety of securable areas other than mailboxes 100. Such as, for example, a room securable by a lockable door, a fenced in yard securable by a lockable gate, and a warehouse securable by lockable bays.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. An energy conserving system for controlling access to a securable area comprising:
a. a transmitter for remotely transmitting a signal;
b. a receiver for receiving the remotely transmitted signal, the receiver including an active state and an inactive state;
c. a logic circuit including an active state and an inactive state and in communication with the receiver;
d. an energy storing device in communication with the logic circuit; and
e. a locking mechanism in communication with the energy storing device;
wherein when the receiver receives the signal from the transmitter, the locking mechanism selectively allows access to the securable area.

2. The energy conserving system of claim 1 wherein the signal comprises:
a. a first portion;
b. a second portion; and
c. a third portion.

3. The energy conserving system of claim 2 wherein the first portion of the signal switches the receiver from the inactive state to the active state if the receiver is in the inactive state.

4. The energy conserving system of claim 2 wherein the second portion of the signal includes a first security code for evaluation by the receiver;
further wherein when the receiver evaluates the first security code, the receiver selectively switches the logic circuit from the inactive state to the active state if the logic circuit is in the inactive state.

5. The energy conserving system of claim 3 wherein the third portion of the signal includes a second security code for evaluation by the logic circuit;
further wherein when the logic circuit evaluates the second security code, the logic circuit selectively commands the energy storing device to open the locking mechanism to unsecure the securable area.

6. The energy conserving system of claim 4 wherein the signal provides energy to the receiver for the receiver to evaluate the first security code.

7. The energy conserving system of claim 1 wherein the energy storing device is a super capacitor.

8. The energy conserving system of claim 1 further comprising a solar cell;
wherein the solar cell is in communication with the energy storing device.

9. The energy conserving system of claim 1 further comprising a piezo device;
wherein the piezo device is in communication with the energy storing device.

10. The energy conserving system of claim 1 wherein the securable area is an internal space of a mail box.

11. The energy conserving system of claim 1 wherein the securable area is an internal space of a room.

12. An energy conserving system for controlling access to a securable area comprising:
a. an RFID transmitter for transmitting a signal;
b. an RFID receiver for receiving the signal, the receiver including an active state and an inactive state;
c. a logic circuit including an active state and an inactive state and in communication with the RFID receiver;
d. an energy storing device in communication with the logic circuit; and
e. a locking mechanism in communication with the energy storing device;
wherein when the RFID receiver receives the signal from the RFID transmitter, the locking mechanism selectively allows access to the securable area.

13. The energy conserving system of claim 12 herein the signal comprises:
a. a first portion, which switches the receiver into the active state if the receiver is in an inactive state;
b. a second portion, which includes a first security code to be evaluated by the RFID receiver; and
c. a third portion, which includes a second security code to be evaluated by the logic circuit;
wherein when the RFID receiver evaluates the first security code, the RFID receiver selectively switches the logic circuit into the active state if the logic circuit is in the inactive state; further wherein, when the logic circuit evaluates the second security code, the logic circuit selectively commands the energy storing device to open the locking mechanism to unsecure the securable area.

14. The energy conserving system of claim 13 wherein the signal provides energy to the RFID receiver for the RFID receiver to evaluate the first security code.

15. The energy conserving system of claim 13 wherein the RFID receiver evaluates the first security code by comparing the first security code to a first access code stored on the RFID receiver.

16. The energy conserving system of claim 13 further comprising a memory circuit;
wherein the logic circuit evaluates the second security code by comparing the second security code to a second access code stored on the memory circuit.

17. The energy conserving system of claim 12 wherein the energy storage device is at least one super capacitor.

18. The energy conserving system of claim 12 further comprising a solar cell;
wherein the solar cell is in communication with the energy storing device.

19. The energy conserving system of claim 12 further comprising a piezo device;
wherein the piezo device is in communication with the energy storing device.

20. The energy conserving system of claim 12 wherein the securable area is the internal space of a mail box.

21. The energy conserving system of claim 12 wherein the securable area is the internal space of a room.

22. A method of securing and unsecuring an access member comprising:
a. transmitting a signal from a transmitter to a securing mechanism, wherein the signal provides the securing mechanism with energy, places the securing mechanism into an active state, and provides a security code to the securing mechanism;
b. using at least a portion of the energy provided by the signal to evaluate the security code;
c. comparing the security code to an access code stored by the securing mechanism;
d. determining whether the security code matches the access code; and
e. unsecuring of the access member with the securing mechanism when the security code matches the access code.

23. The method of claim 22 further comprising:
a. unsecuring the access member by providing energy from the securing mechanism to the access member; and
b. providing energy to the access member from a rechargeable energy storing device within the securing mechanism.

24. The method of claim 22 further comprising:
a. moving the transmitter to a position where the securing mechanism will not receive the transmitted signal;
b. determining that the securing mechanism is no longer receiving the signal;
c. securing the access member; and
d. placing the securing mechanism into an inactive state.
